(19) United States
(12) Patent Application Publication
(10) Pub. No.: US 2018/0136458 A1
(43) Pub. Date: May 17, 2018

(54) SYSTEM FOR DEFLECTING AN OPTICAL RADIATION BEAM AND DEVICE COMPRISING THIS SYSTEM

(71) Applicant: INNTEC.PL Sp. z o.o, GDANSK (PL)

(72) Inventors: JERZY PLUCINSKI, GDANSK (PL); TOMASZ BLOCH, GDANSK (PL)

(21) Appl. No.: 15/567,077

(22) PCT Filed: May 15, 2016
(86) PCT No.: PCT/IB2016/052809

§ 371 Date: Oct. 17, 2017

(30) Foreign Application Priority Data
May 19, 2015 (PL) P.412361

(51) Int. Cl. G02B 26/10; G02B 26/12; B22F 3/105; B28B 1/00; B33Y 30/00; B23K 26/082

(52) U.S. Cl. CPC G02B 26/101; G02B 26/12; B22F 3/1055; B22F 2003/1056; B33Y 30/00; B23K 26/0821; B28B 1/001

(57) ABSTRACT

A system (S) for deflecting an optical radiation beam comprises a first device (D1) for deflecting the input optical radiation beam (B1). The output optical radiation beam (B2) is deflected in a first deflection plane (P1) in the range of the first angle (β1). The system (S) for deflecting the optical radiation beam comprises also a second device (D2) for changing the deflection plane of the output optical radiation beam (B2) at a second angle (β2). After the change of the deflection plane at the second angle (β2) the output optical radiation beam (B2) is deflected in a second deflection plane (P2). The position of the second deflection plane (P2) in respect to the first deflection plane (P1) can be changed, in particular stepwise, by changing the position of the second device (D2) in respect to the first deflection plane (P1).

### TECHNICAL FIELD

This invention relates to a system for deflecting an optical radiation beam and to an optical device comprising this system, in particular an apparatus for scanning the work items with a laser beam, an apparatus for treatment the work items and a 3D printer.

### BACKGROUND OF THE INVENTION

This type of systems for deflecting the optical radiation beam and the optical devices which utilize such system for scanning the work items with the optical radiation beam are known in the art. They have many applications, e.g. for optical printing in a laser printers or for barcode scanning. In those systems are often used a rotating optical elements in the form of rotating mirrors.

Another solution is presented e.g. in U.S. Pat. No. 2,692,370, where is used a galvanometric system of scanning mirrors. The aim of such optical systems is to allow scanning with the optical radiation beam in a given area.

U.S. Pat. No. 5,521,740 A discloses a resonant scanner which can move the mirror at a reduced level of vibrational forces. For this purpose a leaf springs are used for holding a frame of the resonant scanner.

U.S. Pat. No. 3,750,189 proposes an optical system enabling a scanning with an input optical radiation beam, utilizing a rotating element in the form of an regular prism with mirror walls with increased manufacturing tolerances through the use of cylindrical or toroidal lenses. This system thus comprises a first device which is provided for deflecting the input optical radiation beam such that the output optical radiation beam can be deflected in a range of a first angle. Therefore, this document has been chosen as the closest prior art.

U.S. Pat. No. 6,693,255 B2 discloses an apparatus for cleaning a surface of materials utilizing an ablation method induced by a beam of impulse CO₂ laser. The device in the form of manual cleaning head contains a laser and a mirrors directing the laser beam onto the work item.

U.S. Pat. No. 5,751,436 A discloses a systems for laser engraving of an objects. These systems in various combinations contain a sliding tables X or XY, a rotating table and components for scanning with a laser beam, such as rotating prisms, galvanometer scanner and rotating mirror in the form of a regular prism.

U.S. Pat. No. 5,597,589 A discloses a system for selectively sintering a layer of powder for the production of parts made of a number of single sintered layers. This system uses a galvanometric scanner for scanning with a laser beam on the surface of a sintered powder and is utilized to print 3D objects.

However, the optical systems in the prior art do not allow rapid scanning with an optical radiation beam in different planes, i.e. they only allow a quick deflection of the optical radiation beam in a single plane through the mirrors or other reflective elements or deflecting elements of the rotating or spinning elements or resonance deflected about an axis of rotation unchanging its position in space, or they allow slow deflection of the optical radiation beam in different planes, by galvanometric system of scanning mirrors. Wherein the fast scanning is understood as the angular scan speed of not less than 1500 rad/s, and the slow scanning is understood as the angular scan speed of less than 1500 rad/sec. The problem posing a limit on the change of the rotational axis direction of the rotating reflective elements is so-called a gyroscopic effect, which consists in maintaining the spatial orientation of the rotation axis of the rotating object with respect to an inertial reference system. Gyroscopic effect stems from the principle of conservation of angular momentum. Forcing the changes in orientation of the pivot axis requires the application of a relatively large torque and because of the relatively high moment of inertia can't be used as such to change the direction of the axis of rotation of the deflecting elements rotating at high speed.

### PURPOSE OF THE INVENTION

The purpose of the invention is to solve the above mentioned problem. The solution to this problem has been proposed by providing the system for deflecting the optical radiation beam and the device comprising the system, according to the present invention.

### SUMMARY OF THE INVENTION

The system for deflecting the optical radiation beam is characterized in that the system comprises a second device, which is provided for changing a deflection plane of an output optical radiation beam at a second angle, wherein after the change in the deflection plane at the second angle the output optical radiation beam can be deflected in a second deflection plane, different from the first deflection plane, wherein said first device comprises at least one deflecting element.

As used herein the term “input optical radiation beam” should be understood as a beam of optical radiation prior to reflection from the deflecting element disposed on an outer surface of the first deflecting device, and the term “output optical radiation beam” should be understood as a beam of optical radiation after reflection from the deflecting element situated on the outer surface of the first deflecting device, irrespective of the plane in which there are situated said optical radiation beams.

The change in the orientation of the second deflection plane in respect to the first deflection plane can be realized by rotating the second device together with the deflecting element in respect to the first axis of rotation. The deflecting element may be arranged as spaced from the first axis of rotation.

The system for deflecting the optical radiation beam may include a rotor element, which preferably is a regular polygon with a number of a deflecting elements arranged on the outer surface thereof, wherein the second axis of rotation of the rotor element is arranged substantially parallel to the first axis of rotation of the second device.

The rotor element is preferably made with high accuracy, where the tolerances of inclination of facets does not exceed +/−9 arc seconds of arc. The rotor element is preferably driven by an electric motor at a rotational speed in the range of 10 rad/s to 6500 rad/s, preferably from 1000 rad/s to 4200 rad/s, and most preferably at a speed of 1500 rad/s to 2600 rad/s. The number of facets of the rotatable element is 3 to 60, preferably 10 to 30, and most preferably 15 to 25.

In another embodiment, the deflecting element may be moved by a resonant arrangement.

Preferably, the output optical radiation beam can be directed to a system of mirrors of a galvanometric scanner by a deflecting element, wherein before the entry of the output optical radiation beam to the system of mirrors of the galvanometric scanner, an axis of the output optical radiation beam in a central position substantially coincides with the first axis of rotation, and after leaving the galvanometric scanner, the output optical radiation beam can be directed to a f-theta type lens.

The system for deflecting the optical radiation beam is movable in a third plane substantially parallel to a working plane. The movement of the system for deflecting the optical radiation beam in the third plane is provided by a system of guides maintaining the system for deflecting the optical radiation beam, movable in a third plane.

The input optical radiation beam prior to the reflection from the deflecting element can penetrate through a first optical system reducing the diameter of the optical radiation beam, and after being reflected by the deflecting element, as output optical radiation beam can penetrate through a second optical system increasing the diameter of the optical radiation beam.

Preferably, the system for deflecting the optical radiation beam comprises a source of modulated optical radiation, wherein the modulated optical radiation beam generated by the source is guided along the first axis of rotation of the second device.

Preferably, the direction of the input optical radiation beam prior to the reflection from the deflecting element substantially coincides with the first axis of rotation.

A central unit can be provided for modulation of the input optical radiation beam and for controlling the system of mirrors of the galvanometric scanner or the system of guides, said central unit comprising a control unit with which a device with user interface is connected by wires or wireless.

The optical radiation beam may be a laser beam, preferably from an optical amplifier, whose input is provided with the so-called seed laser generating an amplitude modulated beam.

The system for deflecting the optical radiation beam may comprise a mirrors mounted on the adjusting means for precise tracking control of the optical radiation beam and an auxiliary mirrors for changing the direction of the optical radiation beam.

The system for deflecting the optical radiation beam preferably comprises a reference system for detecting the current orientation of the deflecting element. This reference system comprises a reference radiation source for sending the optical radiation beam to the deflecting element and a receiver of the reference radiation reflected from the deflecting element.

Preferably, the system for deflecting the optical radiation beam can be incorporated in an apparatus for processing a work items, in particular their surface, in a device for scanning the work items with an optical beam, or in a 3D printer. Printing with this 3D printer can be performed in layers, wherein the direction of scanning or printing of each layer may be different from the scanning or printing direction of the previous layer.

The invention compared with the prior art enables faster “scanning” or treatment of the work item surface. Experimental studies have shown that 3D printing (printing of three-dimensional objects) is from 2 to 10 times faster comparing to the known 3D printers.

In addition, it has surprisingly turned out that due to the possibility of precision step displacement of the position of the second plane of deflection in respect to the first plane of deflection, it is possible to achieve the directions of scanning forming the adjacent layers of the 3D object, as extending in respect to each other at an given angle, particularly at right angle, and therefore it is possible to achieve a more robust structure of the connections between the individual layers of the resulting 3D object. This more resistant structure of connections between the individual layers is the result of creation of three-dimensional structure similar to the structure of the net.

### BRIEF DESCRIPTION OF DRAWINGS

The embodiments of the invention are illustrated in the drawing, in which each Figure presents:

FIG. 1 Perspective view of the system for deflecting the optical radiation beam in a first embodiment,

FIG. 2 Perspective view of a detail of the system for deflecting the optical radiation beam in a second embodiment,

FIG. 3 Perspective view of a detail of the first embodiment of the invention,

FIG. 4 Perspective view of a detail of the second embodiment of the invention,

FIG. 5 Perspective view of the optical radiation beam deflection system in a third embodiment of the invention for the angle β=90°,

FIG. 6 A side view of the optical radiation beam deflection system of FIG. 5,

FIG. 7 Side view of a detail of a third embodiment of the invention,

FIG. 8 Perspective view of the optical radiation beam deflection system in a third embodiment of the invention for the angle β=0°,

FIG. 9 Perspective view of the optical radiation beam deflection system in the fourth embodiment of the invention,

FIG. 10 A perspective view of a fifth embodiment of the invention—an apparatus for the treatment of produced elements,

FIG. 11 A perspective view of a sixth embodiment of the invention—an apparatus for scanning of produced elements with the optical radiation beam,

FIG. 12 A perspective view of a seventh embodiment of the invention—the 3D printer.

### DETAILED DESCRIPTION OF EMBODIMENTS OF THE INVENTION

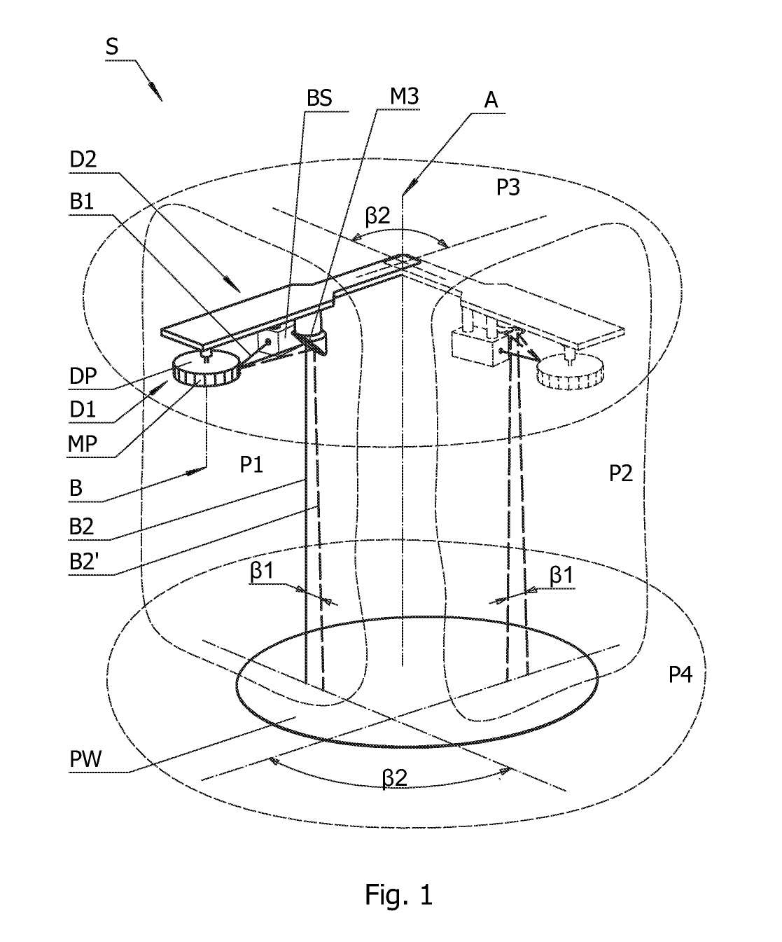

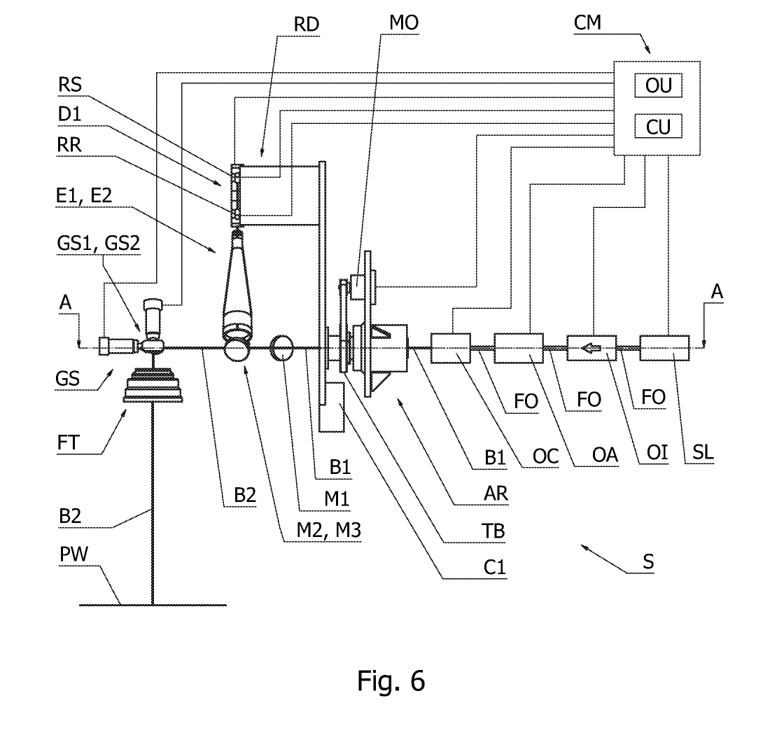

FIG. 1 shows the system S for deflecting of the optical radiation beam in the first embodiment, wherein it comprises a second device D2 in the form of a pivot arm, which is foreseen to change the deflection plane of the output optical beam B2 at the second angle β2. This pivot arm D2 is driven by an electric drive MO, in this case a step motor. By rotation of the pivot arm D2 together with the first device D1 being the rotor element DP in the form of regular prism with the longest diagonal of the base equal 127 mm, height 25.4 mm, with 20 mirror facets MP in the form of deflecting elements positioned on its side surface. The second axis of rotation B of the regular prism DP is substantially parallel to the first axis of rotation A of the pivot arm D2. Rotating of this pivot arm D2 causes a change of the deflection plane at a second angle β2, in this case at 90°, and the output optical beam B2 is deflected in the second deflection plane P2. To the pivot arm D2 is attached a source BS of a modulated input optical radiation in the form of a low-power laser. The modulated input optical radiation beam B1 generated by the low-power laser BS is guided along the pivot arm D2. Modulation of the input optical beam B1 is performed by the central unit CM, comprising a control unit CU, which is wire-connected to the user interface OU. The control system CU is the same in all embodiments, and it is shown in FIG. 6.

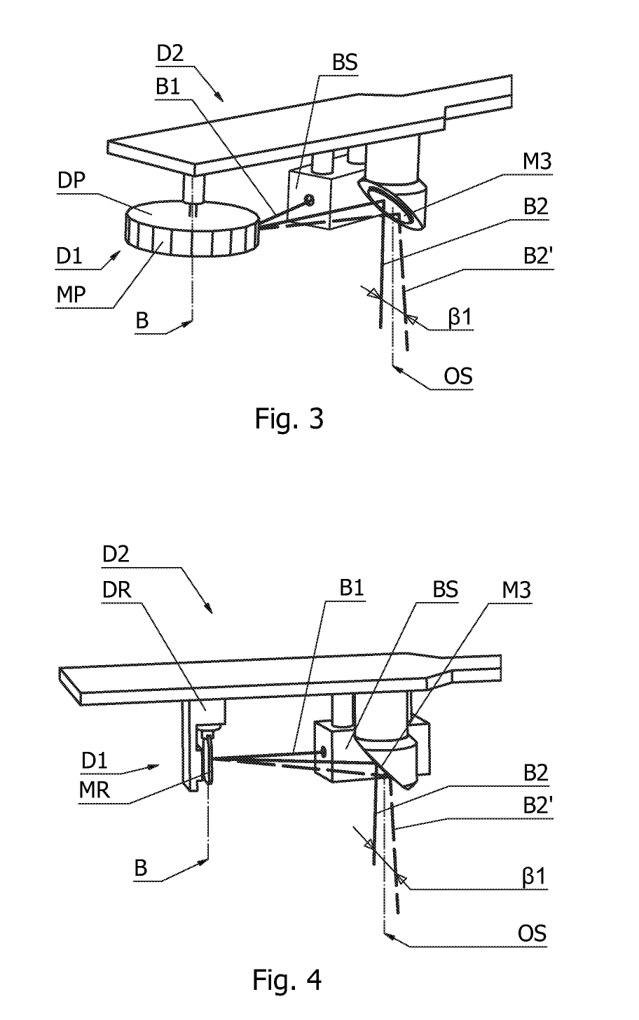

FIG. 3 shows a detail of FIG. 1, showing clearly the elements attached to the pivot arm D2.

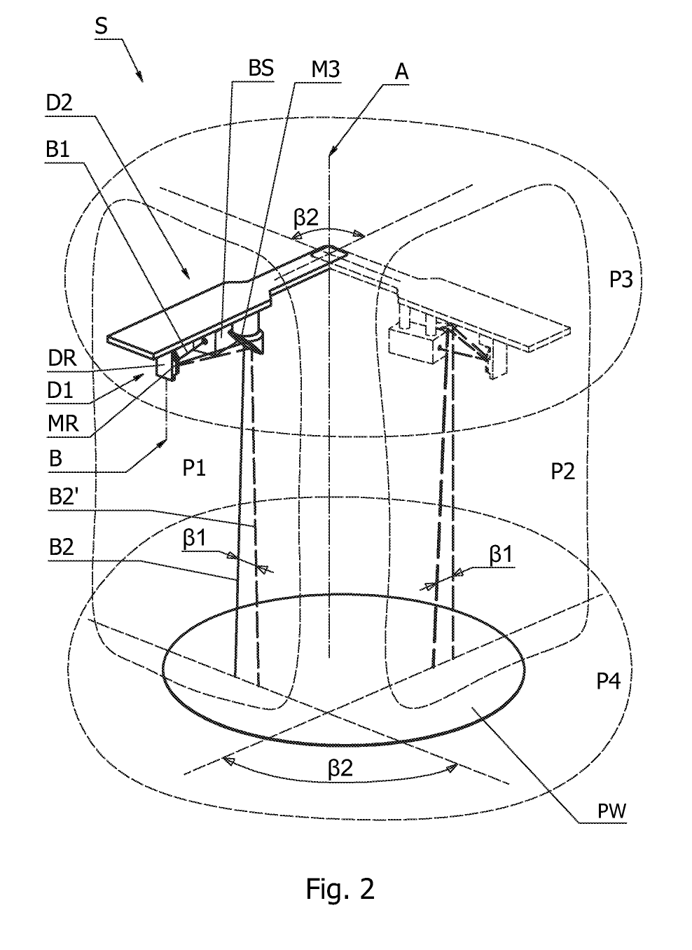

FIG. 2 shows a system S for deflecting the optical radiation beam in the second embodiment, with the pivot arm D2 of substantially the same construction as in the first embodiment and therefore they will not be described again. The difference in this embodiment lies in the fact that the deflection device D1 is a deflecting element MR made in the form of a single mirror rotatably supported about a second axis of rotation B, which during operation of the system is oscillatory pivoted about the second axis of rotation B by the resonant arrangement DR. This resonant arrangement DR can oscillate at a frequency from 200 Hz to 16 kHz, the dimensions of the deflecting element MR are 3 mm×4 mm, the oscillation angle is 0.1 rad.

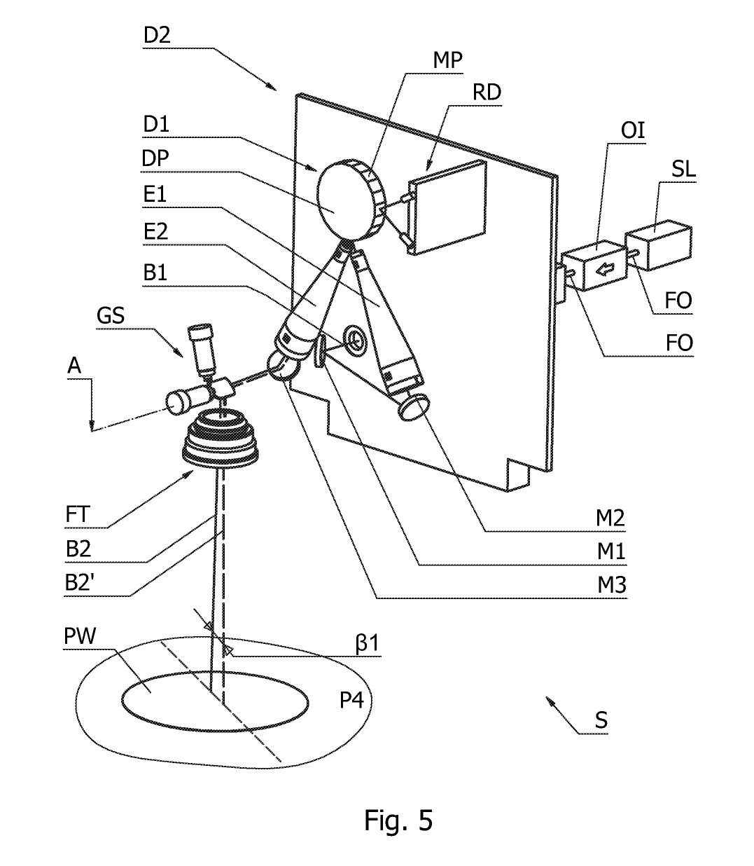

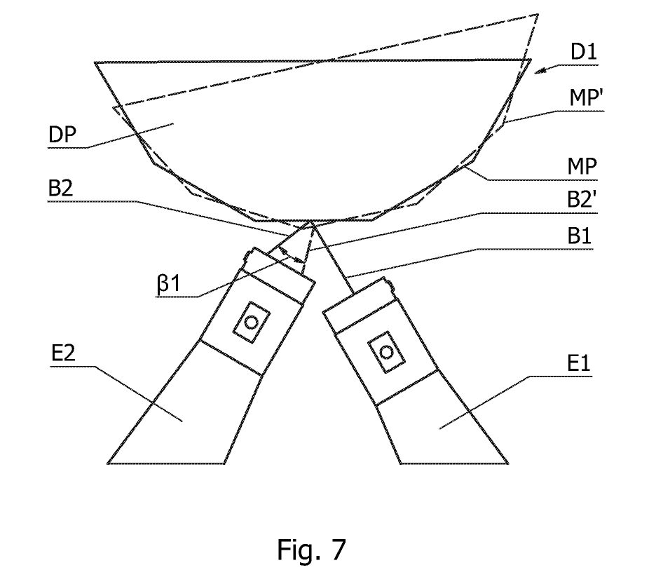

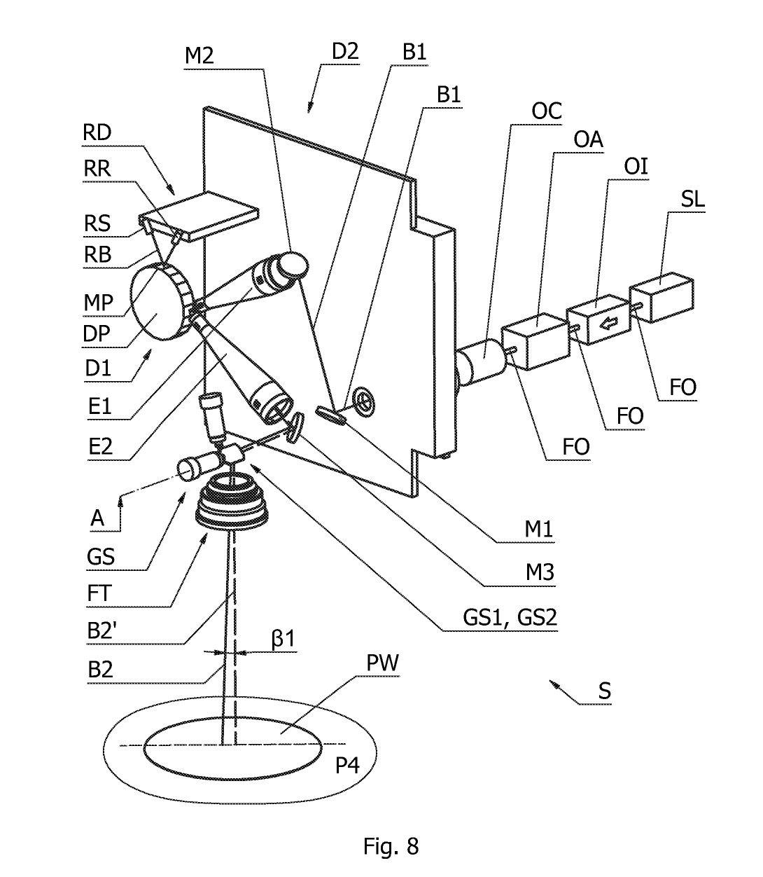

FIG. 4 presents a detail of FIG. 2, showing location of the resonant arrangement DR. The remaining elements of this figure are the same as in the first embodiment shown in FIG. 3. In the third embodiment, shown in FIGS. 5-8, the amplitude-modulated output beam from so-called seed laser SL with an output power of optical radiation of about 100 mW and a wavelength comprised within the range of 1060 nm to 1090 nm is directed by fiber-optic cable FO through an optical isolator OI to an optical amplifier OA. After the amplification of the power to 500 W, the beam is directed further through the fiber-optic cable FO to the collimator OC. From the collimator OC the input optical radiation beam B1 with a diameter of 14 mm is directed through a free space to the deflecting element M1 in the form of a mirror and then to the mirror M2. After the reflection of the beam from the deflecting element M2 in the form of the mirror it is directed through a beam expander E1, reducing the beam diameter to 1.05 mm, to the first device D1 in the form of a rotary mirror DP constructed in the form of a regular prism with the longest diagonal of the base equal 127 mm, height 25.4 mm and 20 mirror facets MP, rotating at a speed of 1947.78 rad/s. The beam reflected from the mirror facets MP of this rotary mirror DP is directed through the beam expander E2 increasing its diameter to the amount of 14 mm to the deflecting element M3 in the form of a mirror, and then to a mirror system GS1, GS2 of the galvanometric scanner GS. The beam reflected from the mirror GS2 is being focused by the f-theta lens FT with a focal length of 420 mm, on the working area PW having dimensions 300 mm by 300 mm, located on the working plane P4. The swirling movement of the rotary mirror DP results in a quick scanning by the beam on the working area PW in a fixed direction. The direction can be changed by rotating the second device D2. The second device D2 comprises elements: the mirrors M1, M2, M3, the beam expanders E1, E2, the rotary mirror DP and the reference system RD for detecting the current position of the deflecting element MP, comprising a source of reference low-power laser radiation RS for sending the optical radiation to the deflecting element DP and a receiver RR of the reference optical radiation reflected from the deflecting element DP. The first axis of rotation A of the second device D2 substantially coincides with the direction of the input optical radiation beam B1 going out from the collimator OC and the direction of the beam reflected from the reflecting element M3 in the form of a mirror. The range of the quick scan is limited to a segment length which is proportional to the scanning angle of the beam created by the rotary mirror DP and the focal length of the f-theta lens FT. The location of a center of this segment length can be changed by adjusting the system of the mirrors GS1, GS2 of the galvanometric scanner GS. Use of the galvanometric scanner GS allows obtaining of the working area with larger dimensions than the length of the segment. The intensity of the beam along the segment is changeable by a system for modulating the seed type laser SL. This solution allows more efficient use of the laser by scanning or production of items with complex shapes.

The third embodiment of the invention also comprises a central unit CM in the form of an industrial computer with card comprising a programmable logic CU, for controlling the modulator of the so-called seed laser SL, the rotary system D2 and the rotary mirror DP, the system of mirrors GS1, GS2 of the galvanometric scanner GS on the basis of the input data from the user interface OU and the information from the reference system RD.

In the third embodiment of the invention, the second device D2 comprises also a fixed part AR with the step motor MO driving through a flexible drive belt transmission TB the movable portion of the second device D2. The moving part of the second device D2 comprises a counterweight C1. Between the fixed portion AR and the movable portion of the second device D2 precision bearings are used.

On FIGS. 5-8 the elements for positioning and fixing the mirrors M1, M2, M3, the beam expanders E1, E2, the rotary mirror DP, the galvanometric scanner GS, the f-thetha lens FT and the reference system RD are omitted for clarity.

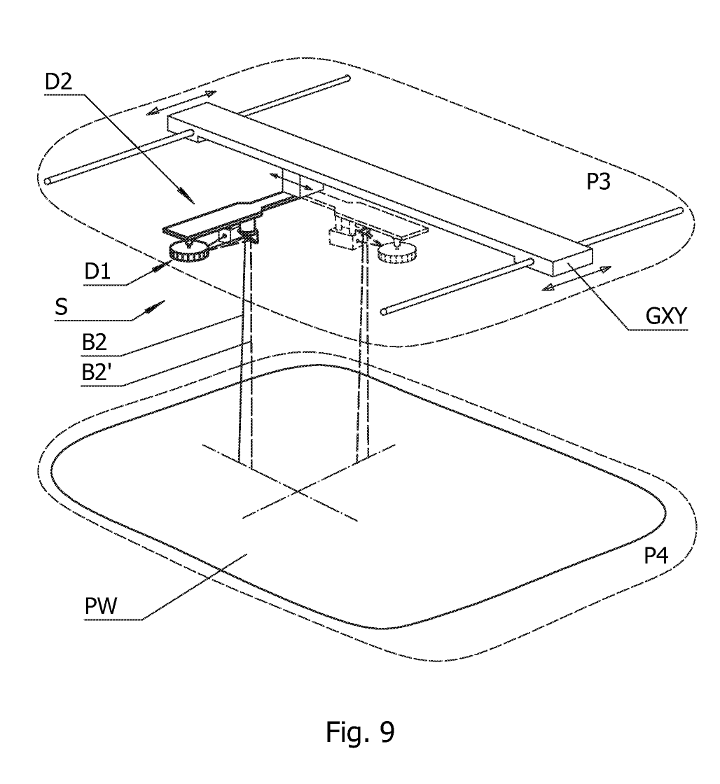

FIG. 9 shows a fourth embodiment of the system S for deflecting the optical radiation beam, which is movable in the third plane P3, substantially parallel to the working plane P4, wherein the movement of the system S for deflecting the optical radiation beam in the third plane P3 is provided by a system of precise guides GXY retaining the system S for deflecting the optical radiation beam, movable in the third plane P3. The guides GXY have dimensions of 1 m×1 m and therefore allow the processing of items with dimensions 1 m×1 m. The construction and operation of such guide systems is well known to persons skilled in the art and does not require detailed description here.

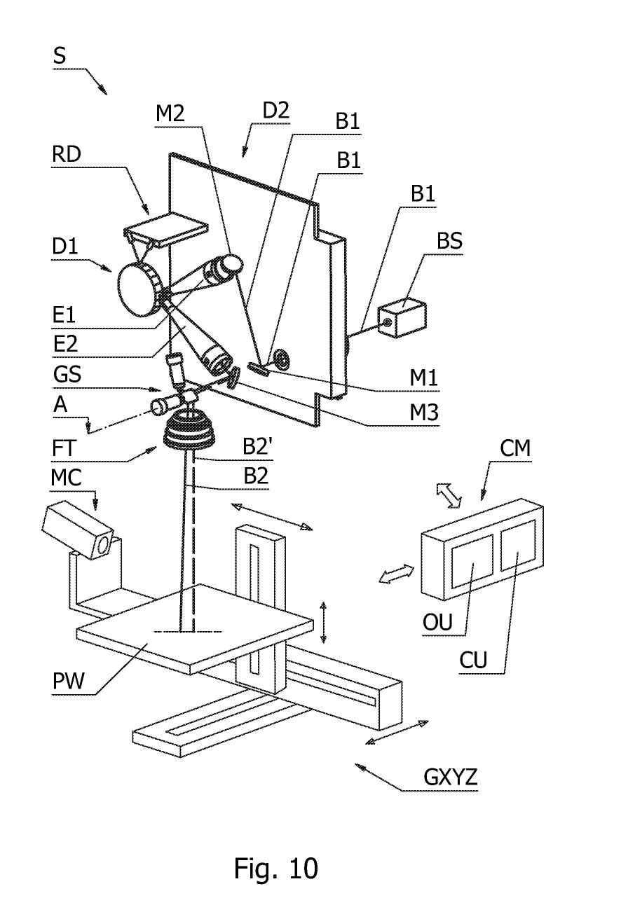

FIG. 10 is a perspective view of a fifth embodiment of the invention, which is a device for treatment of items. In this case, the device is used for cleaning of items by ablation caused by the laser beam. This device comprises a system consisting of a generator of pulse laser beam BS, said generator being a pulsed laser type Nd:YAG with a wavelength of 1064 nm, energy of the pulses to 100 mJ, maximum frequency repetition rate of 50 kHz and the duration of pulses of 10 ns, and the collimator OC, laser beam scanning system (comprising a second device D2, a galvanometric scanner GS and the f-thetha lens FT) the same as in example 3, and a table GXYZ, on which are mounted items to be cleaned, and a microscope system with video camera MC for controlling the accuracy of the current process. The whole process is controlled by the central unit CM comprising the control unit with a programmable logic CU and a device with user interface OU. The control unit CU controls the laser operation and the operation of the scanning system.

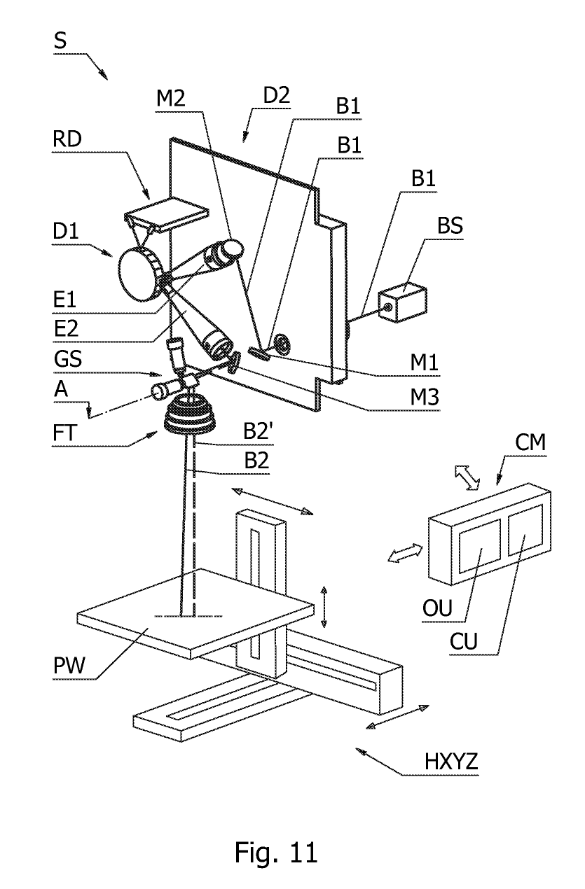

FIG. 11 is a perspective view of a sixth embodiment of the invention—a device for scanning a work items with the optical radiation beam, which in this case is a device for engraving. The device is constructed like the device of the fifth embodiment except that it includes a manually adjustable table HXYZ, engraving software running in the central unit CM, which in this case is a computer, and that it does not comprise the microscope camera.

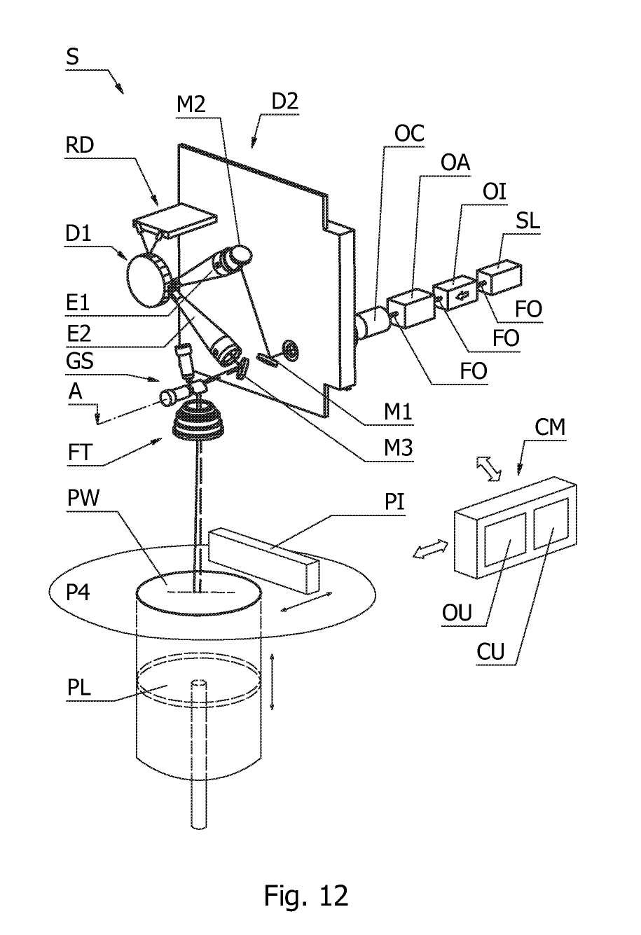

FIG. 12 is a perspective view of a seventh embodiment of the invention—a 3D printer for printing elements of metal and ceramics. This 3D printer comprises a laser beam generating system with the scanning system as in example 3. The laser beam scanning system is connected to the working chamber (for clarity not shown in the drawing), containing the working area PW on the platform PL movable in a vertical direction. On this movable platform PL are applied layers of metal powder or ceramic powder through the powder application device PI. After application of a single layer of the powder takes place its melting in the places, where the laser beam has been applied, thereby forming a single output layer. After the melting the movable platform PL is being lowered by a predetermined value, next layer of powder is applied which is melted and the cycle repeats. The procedure of production of the individual layers is controlled by the central unit CM and is repeated until the entire element is formed. Melting process takes place in an atmosphere of inert gas, in this case argon, which fills up the printing chamber.

For increasing the readability FIGS. 10-12 does not show the connections between the central unit CM and other system components.

The invention has been illustrated in selected embodiments. These embodiments, however, do not limit the invention. It is obvious that modifications can be made without changing the gist of the invention. The presented embodiments do not exhaust the possibilities of application of the invention.

### REFERENCE SIGNS

A—first axis of rotation
AR—fixed part
B—second axis of rotation
B1—input optical radiation beam
B1—modulated input optical radiation beam
B2—output optical radiation beam
BS—source of modulated input optical radiation, low-power laser, generator of pulsed laser beam type Nd:YAG
C1—counterweight
CM—central unit, computer
CU—control unit, programmable logic
D1—first device
D2—second device, pivot arm, rotary system
DP—rotor element, rotary mirror
DP—deflecting element, rotary mirror
DR—resonant arrangement
E1—first optical system, beam expander
E2—second optical system, beam expander
FO—fiber-optic cable
FT—f-thetha lens, f-theta type lens
GS—galvanometric scanner
GS1, GS2—mirror, system of mirrors
GXY—guides, system of guides, system of precise guides
GXYZ—table
HXYZ—table
M1—deflecting element, mirror
M2—deflecting element, mirror
M3—deflecting element, reflecting element, mirror
MC—microscope system with video camera
MO—electric drive, step motor
MP, MR—deflecting element, mirror facet, mirror
OA—optical amplifier
OC—colimator
optical isolator
OS—axis of the output optical radiation beam B2 in the central position
OU—device with user interface, user interface
P1—first deflection plane
P2—second deflection first plane
P3—third plane
P4—working plane
PI—powder application device
PL—movable platform
PW—working area
RD—reference system
RR—receiver of the reference optical radiation
RS—source of reference radiation, source of reference low-power laser radiation
S—system for deflecting the optical radiation beam
SL—seed laser
TB—flexible drive belt transmission
β1—first angle
β2—second angle

1-15. (canceled)

16. A system (S) for deflecting an optical radiation beam, comprising a first device (D1) which is provided for deflecting an input optical radiation beam (B1) in such a manner that an output optical radiation beam (B2) can be deflected at a first angle (β1), characterized in that the system (S) for deflecting the optical radiation beam comprises a second device (D2), which is provided for changing a deflection plane of the output optical radiation beam (B2) at a second angle (β2), wherein after the change in the deflection plane at the second angle (β2) the output optical radiation beam (B2) can be deflected in a second deflection plane (P2) different from a first deflection plane (P1), wherein said first device (D1) comprises at least one deflecting element (MP, MR), wherein the change in the orientation of the second deflection plane (P2) in respect to the first deflection plane (P1) can be realized by rotating the second device (D2) together with the deflecting element (MP, MR) in respect to a first axis of rotation (A), wherein the direction of the input optical radiation beam (B1), prior to reflection from the deflecting element (MP, MR) substantially coincides with the first axis of rotation (A).

17. The system (S) according to claim 16, wherein the system (S) comprises a rotor element (DP), which preferably is a regular polygon with a number of a deflecting elements (MP) arranged on the outer surface thereof, wherein a second axis of rotation (B) of the rotor element (DP) is arranged substantially parallel to the first axis of rotation (A) of the second device (D2).

18. The system (S) according to claim 17, wherein the deflecting element (MR) is arranged to be driven by a resonant arrangement (DR).

19. The system (S) according to claim 16, wherein the output optical radiation beam (B2) can be directed to a system of mirrors (GS1, GS2) of a galvanometric scanner (GS) by a deflecting element (M3), wherein before the entry of the output optical radiation beam (B2) to the system of mirrors (GS1, GS2) of the galvanometric scanner (GS), an axis (OS) of the output optical radiation beam (B2) in a central position substantially coincides with the first axis of rotation (A), and after leaving the galvanometric scanner (GS), the output optical radiation beam (B2) can be directed to a f-theta type lens (FT).

20. The system (S) according to claim 16, wherein the system (S) is movable in a third plane (P3) substantially parallel to a working plane (P4), wherein the movement of the system (S) for deflecting the optical radiation beam in the third plane (P3) is provided by a system of guides (GXY) maintaining the system (S) for deflecting the optical radiation beam, movable in the third plane (P3).

21. The system (S) according to claim 16, wherein the input optical radiation beam (B1) prior to the reflection from the deflecting element (MP, MR) penetrates through a first optical system (E1) reducing the diameter of the input optical radiation beam (B1), and after being reflected by the deflecting element (MP, MR) as output optical radiation beam (B2) penetrates through a second optical system (E2) increasing the diameter of the output optical radiation beam (B2).

22. The system (S) according to claim 16, wherein the system (S) comprises a source (BS) of modulated input optical radiation, wherein the modulated input optical radiation beam (B1) generated by the source (BS) of modulated input optical radiation is guided along the first axis of rotation (A) of the second device (D2).

23. The system (S) according to claim 19, wherein the system (S) comprises a central unit (CM) configured for modulation of the input optical radiation beam (B1) and for controlling the system of mirrors (GS1, GS2) of the galvanometric scanner (GS) or the system of guides (GXY), said central unit (CM) comprising a control unit (CU) with which a user interface device (OU) is connected by wires or wireless.

24. The system (S) according to claim 16, wherein the system (S) comprises a reference system (RD) for detecting the current orientation of the deflecting element (MP, MR), wherein the reference system (RD) comprises a reference optical radiation source (RS) for sending optical radiation to the deflecting element (MP, MR) and a receiver (RR) of the reference optical radiation reflected from the deflecting element (MP, MR).

25. An apparatus for processing a work items, in particular for processing a surface of the work items, wherein the apparatus comprises a system (S) according to claim 16.

26. A device for optical scanning with an optical radiation beam of work items, wherein said device comprises a system (S) according to claim 16.

27. A 3D printer, wherein said 3D printer comprises the system (S) according to claim 16.

28. The 3D printer according to claim 27, wherein printing of a 3D objects can be carried out in layers, wherein the direction of scanning or printing of each layer is different from the scanning direction or printing direction of the previous layer.
